(19) United States
(12) Patent Application Publication
(10) Pub. No.: US 2022/0272531 A1
(43) Pub. Date: Aug. 25, 2022

(54) NETWORK SLICE QUOTA MANAGEMENT DURING NETWORK SLICE SPECIFIC AUTHENTICATION AND AUTHORISATION

(71) Applicant: NEC Corporation, Minato-ku,Tokyo (JP)

(72) Inventors: Iskren IANEV, Lower Earley (GB); Toshiyuki TAMURA, Tokyo (JP)

(73) Assignee: NEC Corporation, Minato-ku,Tokyo (JP)

(21) Appl. No.: 17/627,230

(22) PCT Filed: Dec. 15, 2020
(86) PCT No.: PCT/JP2020/046740

§ 371 Date: Jan. 14, 2022

(30) Foreign Application Priority Data
Dec. 20, 2019 (EP) 192118972.8

(51) Int. Cl. H04W 12/06; H04W 12/088; H04W 12/71

(52) U.S. Cl. CPC H04W 12/06; H04W 12/088; H04W 12/71

(57) ABSTRACT

The present disclosure proposes a solution for monitoring, controlling and enforcement of the number of the UEs per Network Slice quota for Network Slices subject to Network Slice Specific Authentication and Authorisation (NSSAA). It proposes a new Network Slice Quota (NSQ) service and service operations for Network Slice quota subscription, monitoring, update and notification.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to monitoring, controlling, and enforcing the number of UEs per network slice in the so-called ‘5G’ (or ‘Next Generation’) systems.

### ABBREVIATIONS

3GPP 3rd Generation Partnership Project

5GC 5G Core Network

5GS 5G System

5G-AN 5G Access Network

AAA-S Authentication, Authorisation and Accounting Server

AAA-P Authentication, Authorisation and Accounting Proxy

AF Application Function

AMF Access and Mobility Management Function

AUSF Authentication Server Function

DNN Data Network Name

gNB Next generation Node B

GPSI Generic Public Subscriber Identity

GST Generic Slice Template

NAS Non-Access Stratum

NDA Non-Disclosure Agreement

NEF Network Exposure Function

NF Network Function

NG-RAN Next Generation Radio Access Network

NR New Radio

NSQ Network Slice Quota

NSSAA Network Slice Specific Authentication and Authorisation

NSSF Network Slice Selection Function

OAM Operations and Maintenance

PCC Policy and Charging Control

PCF Policy Control Function

PLMN Public Land Mobile Network

(R)AN (Radio) Access Network

RRC Radio Resource Control

SLA Service Level Agreement

UDM Unified Data Management

UDR Unified Data Repository

UE User Equipment

### BACKGROUND ART

For the purposes of the present document, the terms and definitions given in 3GPP Technical Report (TR) 21.905 [1] and the following apply. A term defined in the present document takes precedence over the definition of the same term, if any, in 3GPP TR 21.905 [1].

Network slicing features defined in 3GPP release 15 and release 16 enable a great variety of communication services for operators and verticals alike. To enhance the commercial viability of Network Slicing, GSMA SGJA has introduced in document NG.116 the concept of Generic Slice Template [4] from which several Network Slice Types descriptions can be derived. Some of the parameters in the GST point explicitly to the definition of parameters and bounds on the service delivered to the end customer. However, the enforcement of some of these bounds or of some of these parameters is not supported by the 5GS yet.

For instance, the GST aims at the limitation of the number of PDU sessions per slice, or the number of devices supported per network slice, or the maximum UL or DL data rate per network slice (which is not the same as the AMBR for a UE, rather a rate limitation per UE/S-NSSAI). These parameters cannot be enforced today as the system lacks the ability to do so.

The SA2 SID on Enhancement of Network Slicing Phase 2 [5] aims at identifying the gaps that need to be filled in providing support for the GST parameters enforcement and the suitable solution to address these gaps.

The objective of this study is to identify the gaps in the currently defined 5GS system procedures defined in SA2 owned Technical Specifications to support of GST parameters and to study potential solutions that may address these gaps. The following parameters at least will be under consideration:
Maximum number of UEs per Network Slice
Maximum number of PDU sessions per Network Slice
Maximum UL and DL data rate per UE in a Network Slice

Interaction with SA1 and GSMA is expected for any aspects that need any clarification, as identified as the work progresses.

### SUMMARY OF INVENTION

3GPP SA2 Working Group has already started the study on how to support the Generic Slice Template (GST) parameters enforcement however, the issue with the Service Level Agreement (SLA) quota on the maximum number of UEs per Network Slice when the Network Slice (e.g. S-NSSAI) is subject to Network Slice Specific Authentication and Authorisation (NSSAA) has not been addressed yet.

This document proposes a solution on how to monitor, control and enforce the SLA network slice quota on maximum number of UEs per Network Slice for Network Slices that are subject to Network Slice Specific Authentication and Authorisation (NSSAA).

According to an aspect of the present disclosure, a Network Function node for network slice quota, includes: means for receiving a first request, from a core network node for mobility management, for service operation about quota of a network slice, including information indicating the network slice; and means for sending, to the core network node for mobility management, a first response to the first request, indicating a result of the service operation about the quota of the network slice.

According to another aspect of the present disclosure, a core network node for mobility management, includes: means for sending a first request, to a Network Function node for network slice quota, for service operation about quota of a network slice, including information indicating the network slice; and means for receiving, from the Network Function node for network slice quota, a first response to the first request, indicating a result of the service operation about the quota of the network slice.

According to another aspect of the present disclosure, a controlling method for a Network Function node for network slice quota, the controlling method includes: receiving a first request, from a core network node for mobility management, for service operation about quota of a network slice, including information indicating the network slice; and sending, to the core network node for mobility management, a first response to the first request, indicating a result of the service operation about the quota of the network slice.

According to another aspect of the present disclosure, a controlling method for a core network node for mobility management, the controlling method includes: sending a first request, to a Network Function node for network slice quota, for service operation about quota of a network slice, including information indicating the network slice; and receiving, from the Network Function node for network slice quota, a first response to the first request, indicating a result of the service operation about the quota of the network slice.

### BRIEF DESCRIPTION OF DRAWINGS

FIG. 1 gives a more detailed description of the newly defined Network Slice Quota (NSQ) service and operations.

FIG. 2 demonstrates Network Slice Quota management during Network Slice Specific Authentication and Authorisation (NSSAA) when there is no quota available.

FIG. 3 demonstrates Network Slice Quota management during Network Slice Specific Authentication and Authorisation (NSSAA) when there is available quota.

FIG. 4 demonstrates Network Slice Quota management during Revocation of authorization for the Network Slice Specific Authentication and Authorisation (NSSAA).

FIG. 5 demonstrates Network Slice Quota management after UE Configuration Update procedure.

FIG. 6 demonstrates subscription for Network Slice Quota Notification.

FIG. 7 is a schematically illustrate a mobile (cellular or wireless) telecommunication system 1.

FIG. 8 is a block diagram illustrating the main components of the UE (mobile device 3).

FIG. 9 is a block diagram illustrating the main components of an exemplary (R)AN node 5 (base station).

FIG. 10 is a block diagram illustrating the main components of a generic core network node (or function).

### DESCRIPTION OF EMBODIMENTS

Network Slice Quota management during Network Slice Specific Authentication and Authorisation (NSSAA).

This example aspect describes an exemplary way to monitor, control and enforce the SLA quota restrictions on maximum number of UEs per Network Slice for Network Slices that are subject to NSSAA.

A new Network Slice Quota (NSQ) service is proposed which assumes that the Network Slice Quota is managed by a designated network function (e.g. NSQ—Network Slice Quota function/entity or any other notation for a function or entity which monitors, controls and enforces the maximum numbers of UEs per Network Slice quota (e.g. Service Level Agreements (SLA)). This new NSQ can be a new functional entity within any existing network node (e.g. NSSF, AMF, PCF, NWDAF) or NSQ can be implemented as a new physical entity). The following NSQ Service and NSQ operations are proposed in Table 1 which are applicable in both cases where the NSQ is represented as a part of an existing network node or it is represent as a new designated network node.

TABLE 1
NF Services provided by NSQ

| | Service | Service | Example |
|---|---|---|---|
| Service Name | Operation | Semantic | Consumers |
| Nnsq_NetworkSliceQuota | Availability | Request/ | AMF |
| | Update | Response | AMF |
| | Subscribe | Subscribe/ | AMF |
| | Unsubscribe | Notify | |
| | Notify | | |

Alternatively, the Network Slice Quota can be managed by a designated NSQ function within the NSSF network entity and for this, the present disclosure proposes the following NSQ related service and service operations within the existing NSSF Service, see Table 2.

TABLE 2
Network Slice Quota related Services provided by NSSF

| | Service | Operation | Example |
|---|---|---|---|
| Service Name | Operations | Semantics | Consumer(s) |
| Nnssf_NSSelection | Get | Request/ | AMF, NSSF in |
| | | Response | a different |
| | | | PLMN, SMF |
| Nnssf_NSSAIAvailability | Update | Request/ | AMF |
| | | Response | |
| | Subscribe | Subscribe/ | AMF |
| | Unsubscribe | Notify | AMF |
| | Notify | | AMF |
| | Delete | Request/ | AMF |
| | | Response | |
| Nnssf_NetworkSliceQuota | Availability | Request/ | AMF |
| | Update | Response | AMF |
| | Subscribe | Subscribe/ | AMF |
| | Unsubscribe | Notify | AMF |
| | Notify | | AMF |

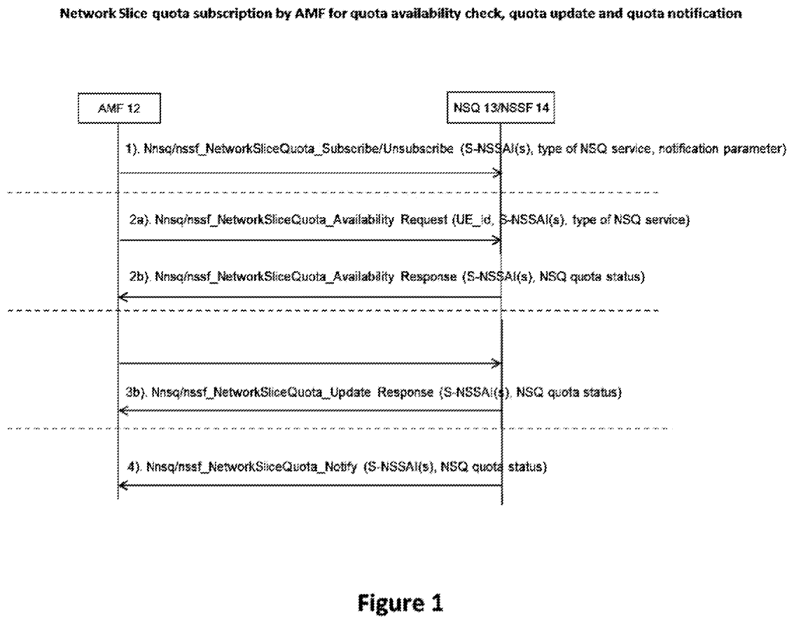

FIG. 1 gives a more detailed description of the newly defined Network Slice Quota (NSQ) service and operations.
Service operation name: Nnsq/nssf_NetworkSliceQuota_Subscribe/Unsubscribe or any other notation for service operation for the purpose of network slice quota services subscription and unsubscription.
Description: This service operation enables the AMF 12 to subscribe or unsubscribe for Network Slice Quota (NSQ) related services, e.g. NSQ quota availability check, NSQ quota update, NSQ quota notification.
Input: the S-NSSAI(s) for which the AMF 12 wishes to subscribe or unsubscribe for NSQ services; the type of NSQ service, e.g. “number of UEs per network slice” quota, “number of PDU sessions per network slice” quota. A plurality of kinds of the type of NSQ services can be included as the parameter. In some example aspects, a new parameter “notification parameter” for indicating the triggers for the Notification, for example, periodic notification, threshold based notification, and event based notification and etc., can be included as parameters.
Service operation name: Nnsq/nssf_NetworkSliceQuota_Availability Request/Response or any other notation for service operation for the purpose of network slice quota availability check.
Description: This service operation enables the AMF 12 to check for the availability of the NSQ quota with the NSQ 13/NSSF 14, e.g. number of UEs per network slice quota availability.
Input (Nnsq/nssf_NetworkSliceQuota_Availability Request) with the following parameters:
the UE_Id which indicates the UE 3 to be checked whether the UE 3 is subject for NSQ control or not (e.g. if the UE 3 has previously been registered with the S-NSSAI for which NSQ quota availability is to be checked and is still in the list of UEs registered with that S-NSSAI).
the S-NSSAI(s) which the quota availability is to be checked. the type of NSQ service (e.g. “number of UEs per network slice” quota, “number of PDU sessions per network slice” quota).
Output (Nnsq/nssf_NetworkSliceQuota_Availability Response) with the following parameters:
the S-NSSAI(s) which the NSQ quota is being checked;
the NSQ quota status—the current status of the NSQ quota e.g. the available quota or the current number of UEs per network slice. A plurality of kinds of the NSQ quota statuses can be included as the parameter.
Service operation name: Nnsq/nssf_NetworkSliceQuota_Update Request/Response or any other notation for service operation for the purpose of network slice quota update.
Description: This service operation enables the AMF 12 to update the number of UEs per network slice quota in the NSQ 13/NSSF 14 for one or more network slices and get back the current status of the quota for these network slices. It may also enable the AMF 12 to update the number of UEs per network slice quota in the NSQ 13/NSSF 14 in case the AMF 12 performs the AMF 12 planed removal procedure or the AMF 12 encounters the restoration procedure.
Input (Nnsq/nssf_NetworkSliceQuota_Update Request) with the following parameters:
The UE_Id(s) which indicates UE(s) that will be added or removed from the network slice quota.
The Node_Id which indicates a node identifier, for example an AMF Name with a globally unique FQDN format, where the Nnsq/nssf_NetworkSliceQuota_Update Request message comes from. In case there is a Node_Id but no UE_Id(s) and the update_flag is set to “decrement” in the Nnsq/nssf_NetworkSliceQuota_Update Request message, the NSQ/NSSF decrements the number of registered UE(s) in the NSQ 13/NSSF 14 which are associated with the Node_Id.
The S-NSSAI(s) indicates for which the network slices quota is to be updated;
The type of NSQ service (e.g. “number of UEs per network slice” quota, “number of PDU sessions per network slice” quota).
The update_flag indicates whether to increment the quota or decrement the quota. Alternatively, the update_flag can indicate whether to increment or decrement the current number of UEs per network slice. Along with the quota increment/decrement, the NSQ 13/NSSF 14 also adds the UE_Id and Node_Id to a list of UEs registered with an S-NSSAI at registration time.
Output (Nnsq/nssf_NetworkSliceQuota_Update Response) with the following parameters:
The S-NSSAI(s) for which the NSQ quota is updated;
the NSQ quota status—the current status of the NSQ quota e.g. the available quota or the current number of UEs per network slice. A plurality of kinds of the NSQ quota statuses can be included as the parameter.
Service operation name: Nnsq/nssf_NetworkSliceQuota_Notify, Nnsq/nssf_NetworkSliceQuota_Notification or any other notation for service operation for the purpose of network slice quota availability notification.
Description: This service operation enables the NSQ/NSSF to notify (regularly or based on a trigger or threshold) the current status of the NSQ quota.
Input: UE_Id; the S-NSSAI(s) for which the quota is being reported; the NSQ quota status—the current status of the NSQ quota e.g. the available quota or the current number of UEs per network slice. A plurality of kinds of the NSQ quota statuses can be included as the parameter.

Use Case 1

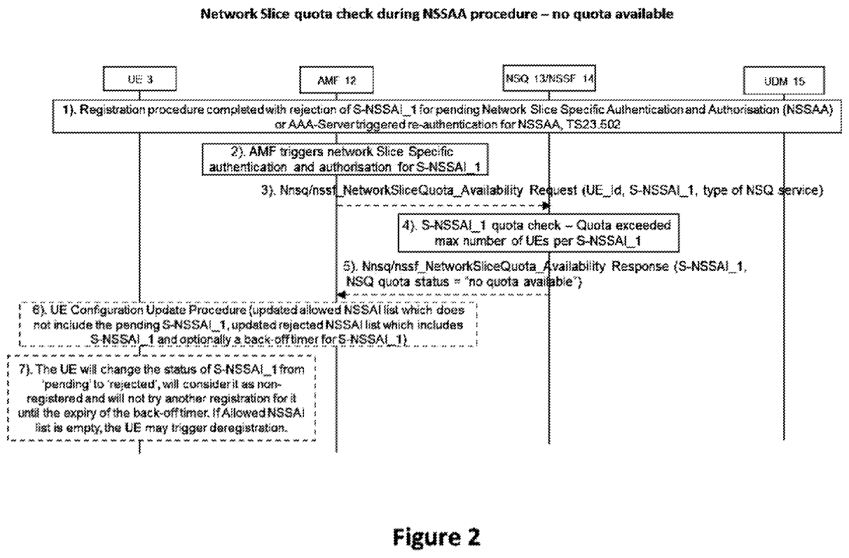

FIG. 2 demonstrates Network Slice Quota management during Network Slice Specific Authentication and Authorisation (NSSAA) when there is no quota available, i.e. the max number of UEs per Network Slice is reached. The example in the FIG. 2 is a demonstration for one network slice, however the use case is equally applicable for one or more network slices.

step 1). A Registration procedure completed with rejection of a S-NSSAI_1 for the pending Network Slice Specific Authentication and Authorisation or the AAA-Server triggered re-authentication for the NSSAA, as per 3GPP Technical Specification (TS) 23.502. The AAA-Server can trigger the re-authentication for Network Slice Specific Authentication and Authorisation at any time. This use case is demonstrated with the S-NSSAI_1 as an example for network slice pending Network Slice Specific Authentication and Authorisation, however, the procedure is equally applicable for one or more network slices (e.g. S-NSSAIs) pending the Network Slice Specific Authentication and Authorisation after the registration procedure. In the registration procedure, it is assumed that for the S-NSSAI(s) rejected for the reason that the Network Slice Specific Authentication and Authorisation is pending, the network slice quota has not been updated for them yet.

step 2). The AMF triggers the network Slice Specific Authentication and Authorisation procedure for the S-NSSAI_1 as per 3GPP TS 23.502, section 4.2.9

step 3). Unless it is triggered by the re-authentication for Network Slice Specific Authentication and Authorisation, the AMF 12 checks for the network slice quota availability. The AMF 12 sends the Nnsq/nssf_NetworkSliceQuota_Availability Request (UE_Id, S-NSSAI_1, type of NSQ service=“number of UE(s) per network slice” quota) message to the Network Slice Quota (NSQ) or any other network entity with which the network slice quota functionality may be co-located, e.g. NSSF, PCF, NWDAF. The AMF 12 includes the following parameters: the UE_Id which indicates the UE 3 to be checked whether the UE 3 is subject for NSQ control and restrictions, the S-NSSAI(s)—one or more S-NSSAI for which the registration is pending, e.g. the S-NSSAI_1; the type of NSQ service whose value is “number of UE(s) per network slice” quota—or any other notation for a flag/parameter which indicates the type of NSQ service;

step 4). The NSQ 13/NSSF 14 checks the UEs per network slice quota availability for the S-NSSAI_1. For this use case, the result is that the max number of UEs per S-NSSAI_1 is exceeded, i.e. no quota available.

In case that the UE_Id is included in the Nnsq/nssf_NetworkSliceQuota_Availability Request message, the NSQ 13/NSSF 14 checks first that the UE_Id has already been previously registered for S-NSSAI_1 (i.e. the UE 3 has already been included in the list of UEs registered with S-NSSAI_1). If the UE_Id is already in the list of UEs registered with S-NSSAI_1, then no further check will be made, i.e. no need for Quota checking. The UE 3 shall not be rejected.

step 5). The NSQ 13/NSSF 14 returns the Nnsq/nssf_NetworkSliceQuota_Availability Response (S-NSSAI_1, NSQ quota status=“no number of UEs per network slice quota available”) message to indicate to the AMF 12 that no quota is available for the S-NSSAI_1.

step 6). If an allowed NSSAI status in the UE 3 needs to be updated (e.g. the Network Slice-Specific Authentication and Authorization took place or the AAA Server triggered Network Slice-Specific Re-authentication and Re-authorization procedure failed), the AMF 12 triggers the UE Configuration Update procedure. The AMF 12 sends the UE Configuration Update (updated allowed NSSAI list which does not include the pending S-NSSAI_1, updated rejected NSSAI list which includes S-NSSAI_1 and optionally a back-off timer for S-NSSAI_1) message to the UE 3 in which the AMF 12 includes as a parameter the updated Allowed NSSAI list which does not include the S-NSSAI_1 and the updated rejected NSSAI list which now includes the S-NSSAI_1. Optionally, the AMF 12 may include a back-off timer for the rejected S-NSSAI_1. Optionally, the AMF 12 may include a specific cause value “No quota available” for the rejected S-NSSAI_1 in the UE Configuration Update message.

step 7). As a result of the UE Configuration Update procedure by the AMF 12, the UE 3 will change the status of the S-NSSAI_1 from ‘pending’ to ‘rejected’ and will consider the S-NSSAI_1 as non-registered. If a back-off timer was included in the UE Configuration Update message, the UE 3 shall not attempt another registration for the network slice for which the back-off timer was returned (e.g. the S-NSSAI_1) until the expiry of the back-off timer. If the Allowed NSSAI list is empty, the UE 3 may trigger deregistration.

Use Case 2

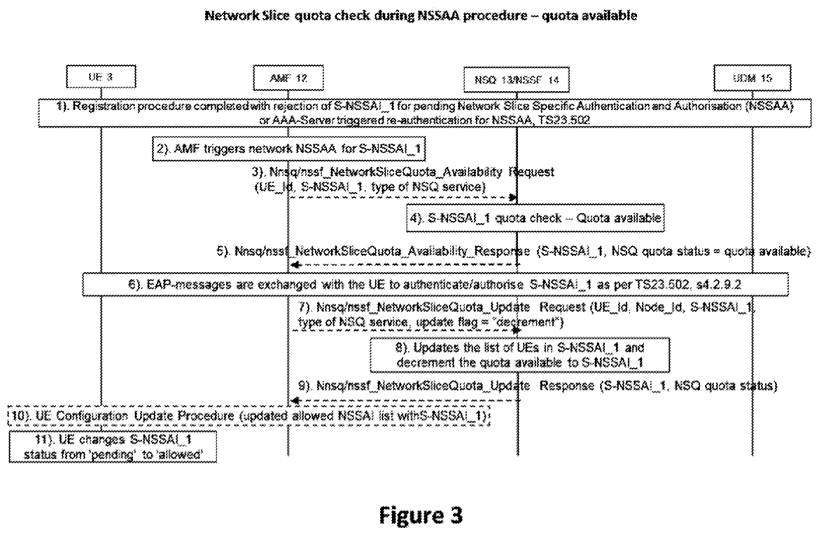

FIG. 3 demonstrates Network Slice Quota management during Network Slice Specific Authentication and Authorisation (NSSAA) when there is available quota, i.e. the max number of UEs per Network Slice is not reached yet.

step 1). A Registration procedure completed with rejection of a S-NSSAI_1 for the pending Network Slice Specific Authentication and Authorisation or the AAA-Server triggered re-authentication for the NSSAA, as per 3GPP TS 23.502. The AAA-Server can trigger re-authentication for Network Slice Specific Authentication and Authorisation at any time. This use case is demonstrated with the S-NSSAI_1 as an example for network slice pending Network Slice Specific Authentication and Authorisation however, the procedure is equally applicable for one or more network slices (e.g. S-NSSAIs) pending the Network Slice Specific Authentication and Authorisation after the registration procedure. In the registration procedure, it is assumed that for the S-NSSAI(s) rejected for the reason that the Network Slice Specific Authentication and Authorisation is pending, the network slice quota has not been updated for them yet.

step 2). The AMF 12 triggers the network Slice Specific Authentication and Authorisation procedure for the S-NSSAI_1 as per 3GPP TS 23.502, section 4.2.9

step 3). Unless it is triggered by the re-authentication for Network Slice Specific Authentication and Authorisation, the AMF 12 checks for the network slice quota availability. The AMF 12 sends the Nnsq/nssf_NetworkSliceQuota_Availability Request (UE_Id, S-NSSAI_1, type of NSQ service=“number of UE(s) per network slice” quota) message to the Network Slice Quota (NSQ) or any other network entity with which the network slice quota functionality may be co-located, e.g. NSSF 14, PCF 16, NWDAF. The AMF 12 includes the following parameters: the UE_Id which indicates the UE 3 to be checked whether the UE 3 is subject for NSQ control and restrictions, the S-NSSAI(s)—one or more S-NSSAI for which the registration is pending, e.g. the S-NSSAI_1; the type of NSQ service whose value is “number of UE(s) per network slice” quota—or any other notation for a flag/parameter which indicates the type of NSQ service;

step 4). The NSQ 13/NSSF 14 checks the UEs per network slice quota availability for the S-NSSAI_1. For this use case, the result is that the max number of UEs per S-NSSAI_1 is not exceeded, i.e. quota is available. In case that a UE_Id is included in the Nnsq/nssf_NetworkSliceQuota_Availability Request message, the NSQ 13/NSSF 14 checks first that the UE_Id has already been included in the list of UEs for the S-NSSAI_1. If the UE_Id has already been registered (i.e. it is in the list of UEs registered with S-NSSAI_1), then no further check will be made, i.e. no need for Quota checking. The UE 3 shall not be rejected.

step 5). The NSQ 13/NSSF 14 returns the Nnsq/nssf_NetworkSliceQuota_Availability Response (S-NSSAI_1, NSQ quota status=“number of UEs per network slice quota available”) message to indicate to the AMF 12 that the quota is available for the S-NSSAI_1.

step 6). EAP-messages are exchanged between the authentication server (e.g. AAA-Server) and the UE 3 Network Slice Specific Authenticate and Authorisation for S-NSSAI_1 as per 3GPP TS 23.502, section 4.2.9.2

step 7). The AMF 12 may update the network slice quota. If the network slice quota needs to be updated, the AMF 12 sends the Nnsq/nssf_NetworkSliceQuota_Update Request (UE_Id, Node_Id, S-NSSAI_1, type of NSQ service=“number of UE(s) per network slice” quota, update_flag=“decrement”) message to the Network Slice Quota (NSQ) or any other network entity with which the network slice quota functionality may be co-located, e.g. NSSF 14, PCF 16, NWDAF. The AMF 12 includes the following parameters: the UE_Id, the Node_Id, the S-NSSAI(s)—one or more S-NSSAI for which the registration is subject to the Network Slice Specific Authentication and Authorisation, e.g. the S-NSSAI_1; the type of NSQ service whose value is “number of UE(s) per network slice” quota to indicate the type of NSQ service to be updated and an update_flag whose value is “decrement” to indicate for the quota for the S-NSSAI_1 to be decremented as a new UE 3 is being registered for the S-NSSAI_1. Note that “the quota to be decremented” means that the rest of quota to be decremented, i.e. the number of registered UEs for the quota to be incremented.

step 8). The NSQ 13/NSSF 14 updates the list of UEs in the S-NSSAI_1 by adding the UE_Id to the list of UEs registered for the NSSAI_1 and decrements the quota available to the S-NSSAI_1. Alternatively, instead decrementing the available quota for the S-NSSAI_1, the NSQ 13/NSSF 14 may instead increase the number of UEs registered with the S-NSSAI_1 which can later be compared with the max number of UEs allowed for that S-NSSAI_1 for deciding whether a quota for the S-NSSAI_1 is available or not. In case there is a Node_Id but no UE_Id(s) and the update_flag is set to “decrement” in the Nnsq/nssf_NetworkSliceQuota_Update Request message, the NSQ 13/NSSF 14 decrements the number of registered UE(s) in the NSQ 13/NSSF 14 which are associated with the Node_Id.

step 9). The NSQ 13/NSSF 14 returns the Nnsq/nssf_NetworkSliceQuota_Update Response (S-NSSAI_1, NSQ quota status) message in which the NSQ 13/NSSF 14 includes the remaining quota for the S-NSSAI_1. Alternatively the NSQ 13/NSSF 14 may indicate the current number of UEs registered for the S-NSSAI_1.

step 10). If an allowed NSSAI status in the UE 3 needs to be updated (i.e. the Network Slice-Specific Authentication and Authorization took place or the AAA Server triggered Network Slice-Specific Re-authentication and Re-authorization procedure failed), the AMF 12 triggers the UE Configuration Update procedure. The AMF 12 sends the UE Configuration Update (updated allowed NSSAI list which it includes S-NSSAI_1) message to the UE 3 in which the AMF 12 includes as a parameter the updated Allowed NSSAI list which now includes S-NSSAI_1.

step 11). As a result of the UE Configuration Update procedure by the AMF 12, the UE 3 will change the status of the S-NSSAI_1 from ‘pending’ to ‘allowed’ and will consider the S_NSSAI_1 as a registered network slice. If not all network slices in the updated Allowed NSSAI list are served by the same AMF 12, the AMF 12 may trigger the AMF re-allocation procedure.

Use Case 3

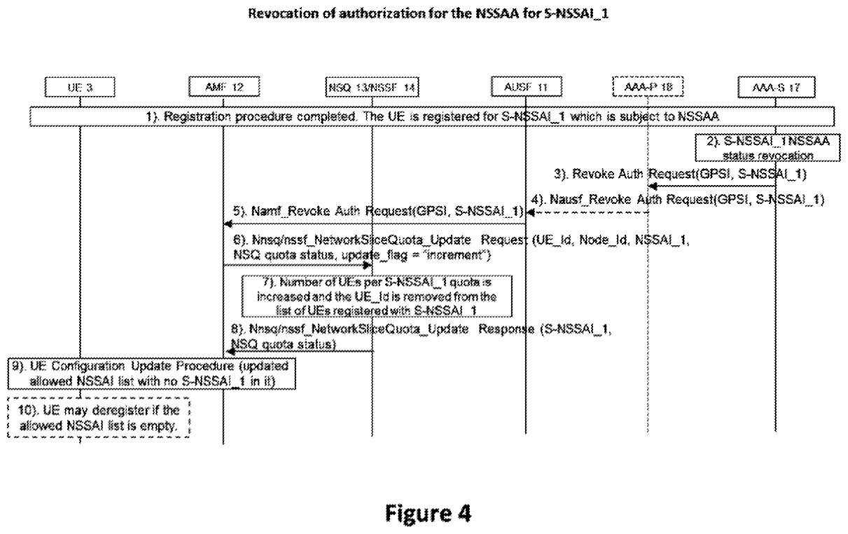

FIG. 4 demonstrates Network Slice Quota management during Revocation of authorization for the Network Slice Specific Authentication and Authorisation (NSSAA).

step 1). A Registration procedure completed with registration to one or more S-NSSAI(s) where in this use case the S-NSSAI_1 is subject to the Network Slice Specific Authentication and Authorisation. The procedure is equally applicable for one or more registered S-NSSAIs that are subject to the Network Slice Specific Authentication and Authorisation.

step 2). The AAA-S 17 requests the revocation of authorization for the Network Slice specified by the S-NSSAI_1 in the Revoke Authorization Request message for the UE 3 identified by the GPSI in this message.

step 3). If the AAA-Server is outside the 3GPP operator's domain, the AAA-Proxy from the network operator's domain is used to relay the revocation request to the Auth node.

step 4). The AAA-P 18 Node forwards the Revoke Auth Request message to the Auth Node

step 5). The AUSF 11 sends Nausf Revoke Auth Request (GPSI, S-NSSAI_1) message to the relevant AMF 12 to revoke the S-NSSAI_1 Network Specific Authentication and Authorisation for the UE 3. The procedure is also valid when the AUSF 11 triggers the normal re-authentication procedure and the procedure fails or when the UDM 15 triggers a normal subscription revocation for network slice.

step 6). The AMF 12 updates the UEs per network slice quota. The AMF 12 sends Nnsq/nssf_NetworkSliceQuota_Update Request (UE_Id, Node_Id, S-NSSAI_1, type of NSQ service=“number of UE(s) per network slice” quota, update flag=“increment”) message to the Network Slice Quota (NSQ) or any other network entity with which the network slice quota functionality may be co-located, e.g. NSSF 14, PCF 16, NWDAF. AMF 12 includes the following parameters: the UE_Id, the S-NSSAI(s)—one or more S-NSSAI for which the registration is subject to the Network Slice Specific Authentication and Authorisation, e.g. the S-NSSAI_1; the type of NSQ service whose value is “number of UE(s) per network slice” quota to indicate the type of NSQ service to be updated and an update_flag whose value is increment to indicate for the quota for the S-NSSAI_1 to be incremented as the UE 3 is being revoked for the S-NSSAI_1. Note that “the quota to be increment” means that the rest of quota to be incremented, i.e. the number of registered UEs for the quota to be decremented.

step 7). The NSQ 13/NSSF 14 updates the list of UEs in the S-NSSAI_1 by removing the UE_Id from the list of UEs registered for the NSSAI_1 and increments the quota available to S-NSSAI_1. Alternatively, instead incrementing the available quota for the S-NSSAI_1, the NSQ 13/NSSF 14 may instead decrease the number of UEs registered with the S-NSSAI_1 which can later be compared with the max number of UEs allowed for that S-NSSAI_1 for deciding whether a quota for the S-NSSAI_1 is available or not. In case there is a Node_Id but no UE_Id(s) and the update_flag is set to “decrement” in the Nnsq/nssf_NetworkSliceQuota_Update Request message, the NSQ 13/NSSF 14 decrements the number of registered UE(s) in the NSQ 13/NSSF 14 which are associated with the Node_Id.

step 8). The NSQ 13/NSSF 14 returns the Nnsq/nssf_NetworkSliceQuota_Update Response (S-NSSAI_1, NSQ quota status) message in which the NSQ 13/NSSF 14 includes the remaining quota for the S-NSSAI_1. Alternatively the NSQ 13/NSSF 14 may indicate the current number of UEs registered for the S-NSSAI_1.

step 9). The AMF 12 updates the UE configuration to revoke the S-NSSAI_1 from the current Allowed NSSAI for any Access Type for which the Network Slice Specific Authentication and Authorization had been successfully run on this S-NSSAI_1. The UE Configuration Update message may include a request to register if the AMF 12 needs to be re-allocated. The AMF 12 provides a new Allowed NSSAI list to the UE 3 by removing the S-NSSAI_1 for which authorization has been revoked. The AMF 12 provides new rejected NSSAIs list to the UE 3 including the S-NSSAI_1 for which authorization has been revoked. If no S-NSSAI is left in Allowed NSSAI list for an access after the revocation, and a Default NSSAI exists that requires no Network Slice Specific Authentication or for which a Network Slice Specific Authentication did not previously fail over this access, then the AMF 12 may provide a new Allowed NSSAI to the UE 3 containing the Default NSSAI.

step 10). If no S-NSSAI is left in the Allowed NSSAI for an access after the revocation, and no Default NSSAI can be provided to the UE 3 in the Allowed NSSAI or a previous Network Slice Specific Authentication failed for the Default NSSAI over this access, then the AMF 12 shall execute the Network-initiated deregistration procedure for the access and it shall include in the explicit De-Registration Request message the list of Rejected S-NSSAIs, each of them with the appropriate rejection cause value.

In this case, it is assumed that the network slice quota in the NSQ 13/NSSF 14 will not be updated during the Network-initiated deregistration procedure as it has been incremented in step 7. Alternatively, the AMF 12 does not initiate the Nnsq/nssf_NetworkSliceQuota_Update operation as indicated in the step 6 in case the AMF 12 understands that the UE 3 is about to be deregistered in step 10. With this treatment, the network slice quota in the NSQ 13/NSSF 14 can always be updated by the deregistration procedure in case the UE 3 is to be deregistered from the network.

Use Case 4

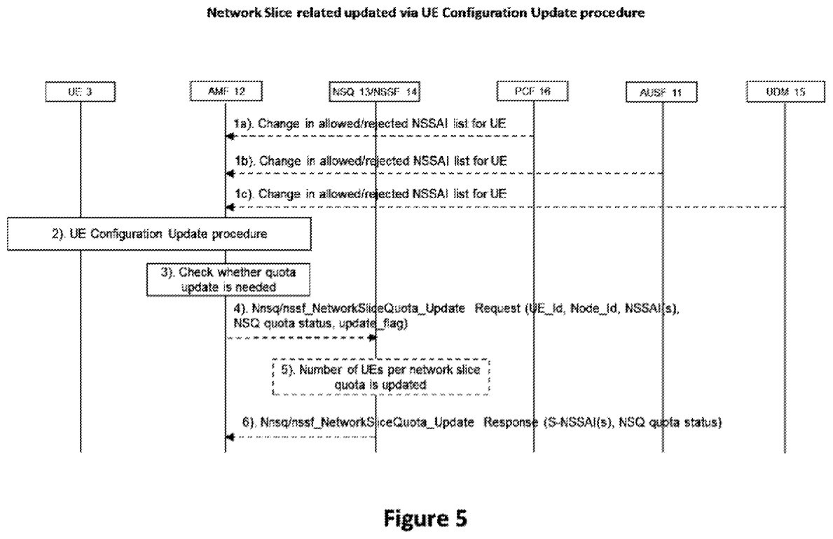

FIG. 5 demonstrates Network Slice Quota management after UE Configuration Update procedure.

This Use case is characterized to update the network slice quota after the successful NSSAI status update to the UE 3.

step 1). Change in Allowed or Rejected NSSAI lists—The S-NSSAIs in the UE 3 Allowed NSSAI list and the UE 3 Rejected NSSAI list can change at any time, for example when the UE 3 changes Tracking Area. The sources of change can be various, for example, the PCF 16 when network slice related restrictions apply or are lifted; the AUSF 11 when re-authentication is triggered and failed; and the UDM 15 when a network slice related subscription is updated. All these changes in the network slice status are indicated to the AMF 12 which is responsible for the network slice status update in the UE 3.

step 2). UE Configuration Update procedure—When the network slice status related to a UE changes, the AMF 12 triggers the UE Configuration Update procedure, see 3GPP TS 23.502. If the UE 3 is in Idle mode, the AMF 12 first pages the UE 3 and then sends the UE Configuration Update message.

step 3). The AMF 12 checks whether the UE Configuration Update procedure impacts the network slices the UE 3 is registered with, e.g. the Allowed NSSAI list or the Rejected S-NSSAI list for the UE 3 are updated.

step 4). If the UE 3 Allowed or Rejected NSSAI list are updated by the UE Configuration procedure and the updated S-NSSAI(s) are subject to the network slice quota control and enforcement, the AMF 12 sends the network slice quota update request to the NSQ 13/NSSF 14—Nnsq/nssf_NetworkSliceQuota_Update Request (UE_Id, Node_Id, S-NSSAI(s), type of NSQ service, update flag). The AMF 12 includes the following parameters: UE_Id, S-NSSAI(s)—one or more S-NSSAI has changed their status, e.g. became allowed or rejected; the type of NSQ service whose value is “number of UE(s) per network slice” quota to indicate the type of NSQ service to be updated and an update_flag to indicate for each S-NSSAI whether the quota is incremented or decremented, e.g. incremented for a new allowed S-NSSAI and decremented for a new rejected S-NSSAI.

step 5). The NSQ 13/NSSF 14 updates the list of UEs registered in the indicated S-NSSAI(s) in accordance with the contents of the Nnsq/nssf_NetworkSliceQuota_Update Request message in step 4.

step 6). The NSAQ13/NSSF 14 responds with NSQ 13/NSSF 14 returns the Nnsq/nssf_NetworkSliceQuota_Update Response (S-NSSAI(s), NSQ quota status) message in which the NSQ 13/NSSF 14 includes the remaining quota for the S-NSSAI(s) the UE 3 is registered.

Note that step 3 to step 6 can take place right before the AMF 12 sends the UE Configuration Update Command message to the UE 3.

Note that step 3 to step 6 can take place after the AMF 12 sends the UE Configuration Update Command message to the UE 3 but before the AMF 12 receives the UE Configuration Update Complete message from the UE 3.

Use Case 5

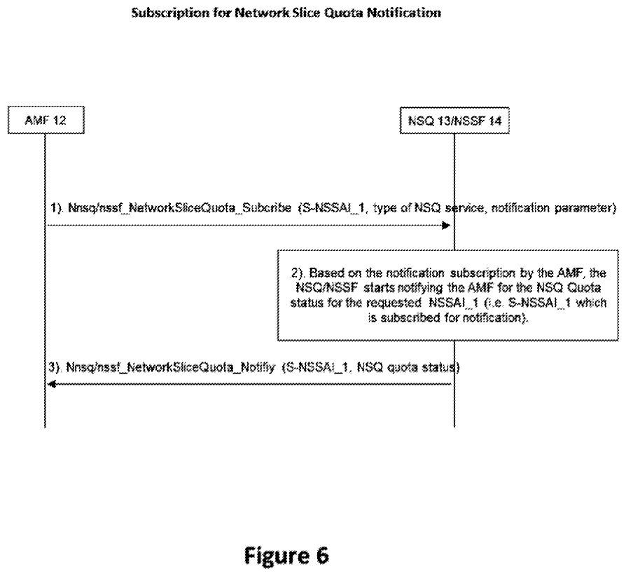

FIG. 6 demonstrates subscription for Network Slice Quota Notification. The example figure demonstrates a subscription for the S-NSSAI_1, however, it is valid for the case of more than one S-NSSAIs as well.

step 1). The AMF 12 requests subscription for the Network Slice Quota (NSQ) Notification service by sending the Nnsq/nssf_NetworkSliceQuota_Subcribe (S-NSSAI_1, type of NSQ service=“number of UEs per network slice” quota) message to the NSQ 13/NSSF 14. The AMF 12 includes as input parameters the S-NSSAI(s) for which a NSQ Notification service is required (e.g. the S-NSSAI_1), the type of NSQ service (e.g. “number of UEs per network slice” quota), and a notification parameter. The notification parameter can be of structure type and can further indicate the triggers for the Notification, for example periodic notification, threshold based notification, event based notification.

step 2). The NSQ 13/NSSF 14 subscribes the AMF 12 for one of the bellow types of NSQ Notification for the requested S-NSSAI(s), e.g. the S-NSSAI_1.
periodic Notification—the NSQ quota status (in terms of UE quota availability as a number or the current number of UEs per network slice) is notified periodically periodicity required by the AMF 12.
threshold triggered Notification—the NSQ quota status (in terms of UE quota availability as a number or the current number of UEs per network slice) is notified when the quota reaches a threshold (e.g. a defined by the AMF 12 in the subscription request or defined by the operator).
event triggered Notification—the NSQ quota status (in terms of UE quota availability as a number or the current number of UEs per network slice) is notified to the AMF 12 based on event trigger (e.g. the UE 3 moves to roaming partner or to a designated area and etc.).

step 3). The NSQ 13/NSSF 14 sends the Nnsq/nssf_NetworkSliceQuota_Notify (S-NSSAI_1, NSQ quota status) to the AMF 12. The NSQ 13/NSSF 14 includes the following parameters in the Notification message: S-NSSAI(s) for which the Notified quota applies (e.g. the S-NSSAI_1) and the NSQ quota status in terms of UE quota availability as a number or the current number of UEs per network slice.

Summary

Beneficially, the above described example aspects include, although they are not limited to, one or more of the following functionalities:

UEs per network slice quota management subscription by the AMF 12 with the NSQ 13/NSSF 14. The AMF 12 may subscribe or unsubscribe with the NSQ 13/NSSF 14 for the following services:
UEs per network slice quota availability check during a NSSAA procedure. The NSQ 13/NSSF 14 checks on the request from the AMF 12 the quota availability for one or more S-NSSAIs and returns quota available or quota not available result.

input—The AMF 12 requests for quota availability check with the NetworkSliceQuota_Availability Request message in which it includes the UE_Id, the S-NSSAI(s) subject to quota check and a flag to indicate which type of NSQ service to check.

processing—the NSQ 13/NSSF 14 checks whether the requested quota is available output—The NSQ 13/NSSF 14 returns the quota available/not available result to the AMF 12. Based on the output, the AMF 12 EITHER cancels the NSSAA procedure and rejects the S-NSSAI(s) for which the quota is not available by removing it from the UE 3's allowed NSSAI list and thus enforcing the quota restrictions and also saving time, recourses and signaling OR continues with the NSSAA procedure if the quota is available.
UEs per network slice quota update during the NSSAA procedure. The NSQ 13/NSSF 14 updates on request from the AMF 12 the quota (increase or decrease) for the requested S-NSSAI(s).

input—The AMF 12 requests for quota update with the NetworkSliceQuota_Update Request message in which it includes the UE_Id, Node_Id, S-NSSAI(s) subject to quota update and a flag to indicate increase or decrease of the quota.

processing—the NSQ 13/NSSF 14 increases or decreases the quota based on the request from the AMF 12. The NSQ also adds or removes the UE_Id in/from a list/table so that the quota is verifiable. output—The NSQ 13/NSSF 14 returns responds to the AMF 12 with NetworkSliceQuota_Update Response and indicate the S-NSSAI(s) and it may also indicate the current quota status. Based on the output, the AMF 12 updates the UE 3 with an allowed NSSAI list which contains the S-NSSAI for which the NSSAA procedure completed successfully, i.e. these S-NSSAI(s) change status from ‘pending’ to ‘allowed’.
UEs per network slice quota notification during the NSSAA procedure. The NSQ 13/NSSF 14 may regularly or upon a trigger (e.g. change of quota) notify the AMF 12 on the current quota status.

In order to provide these functionalities, the above example aspects describe exemplary methods comprising (at least some of) the following steps.

UEs per network slice quota management subscription by the AMF 12 with the NSQ 13/NSSF 14. The AMF 12 may subscribe or unsubscribe with the NSQ 13/NSSF 14 for the following services.

1) UEs per network slice quota availability check during a NSSAA procedure. The NSQ 13/NSSF 14 checks on request from the AMF 12 the quota availability for one or more S-NSSAIs and returns quota available or quota not available result.

2) UEs per network slice quota update during the NSSAA procedure. The NSQ 13/NSSF 14 updates on request from the AMF 12 the quota (increase or decrease) for the requested S-NSSAI(s).

3) UEs per network slice quota notification during the NSSAA procedure. The NSQ 13/NSSF 14 may regularly or upon a trigger (e.g. change of quota) notify the AMF 12 on the current quota status.

Benefits

Some example aspects of the present disclosure allow for monitoring and control of the number of the UEs registered in a Network Slices that are subject to Network Slice Specific Authentication and Authorisation during the Network Slice Specific Authentication and Authorisation procedure and Authorisation subscription revocation procedure. Some example aspects of the present disclosure also enforce access and service restrictions in a network slice which is subject to Network Slice Specific Authentication and Authorisation when the maximum number of UEs per network slice quota is reached.

System Overview

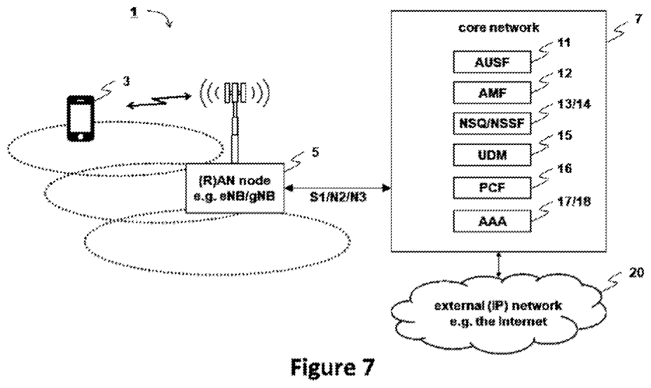

FIG. 7 schematically illustrates a mobile (cellular or wireless) telecommunication system 1 to which the above example aspects are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 (RAN) are shown in FIG. 7 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA/4G protocols may be referred to as an ‘reNB’ and a base station 5 that supports Next Generation/5G protocols may be referred to as a ‘rgNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5 is also connected to the core network nodes via an appropriate interface (such as the so-called ‘S1’, ‘N2’, ‘N3’ interface, and/or the like). Non-Access-Stratum (NAS) interface (such as the so-called ‘N1’ interface, and/or the like) is connected between the mobile device 3 and the core network node via the base station 5.

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs). It will be appreciated that the core network 7 may also include, amongst others: an Authentication Server Function (AUSF) 11, an Access and Mobility Management Function (AMF) 12; an Network Slice Quota (NSQ) 13/an Network Slice Selection Function (NSSF) 14; a Unified Data Management (UDM) 15; a Policy Control Function (PCF) 16, and an Authentication, Authorisation and Accounting Server(AAA-S)17/an Authentication, Authorisation and Accounting Proxy (AAA-P) 18. From the core network 7, connection to an external IP network/data network 20 (such as the Internet) is also provided.

The components of this system 1 are configured to perform one or more of the above described example aspects.

User Equipment (UE)

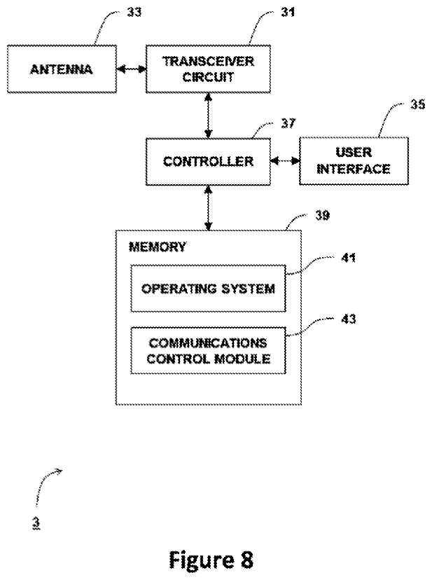

FIG. 8 is a block diagram illustrating the main components of the UE (mobile device 3) shown in FIG. 7. As shown, the UE 3 includes a transceiver circuit 31 which is operable to transmit signals to and to receive signals from the connected node(s) via one or more antenna 33. Although not necessarily shown in FIG. 8, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41 and a communications control module 43. The communications control module 43 is responsible for handling (generating/sending/receiving) signaling messages and uplink/downlink data packets between the UE 3 and other nodes, including (R)AN nodes 5, and core network nodes. Such signaling includes appropriately formatted requests and responses relating to monitoring, controlling, and enforcing the number of UEs per network slice.

(R)AN Node

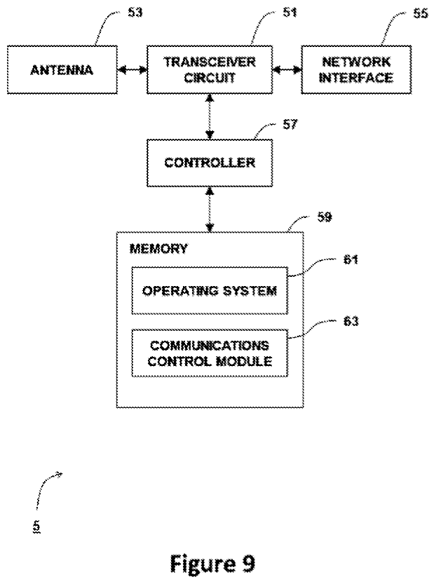

FIG. 9 is a block diagram illustrating the main components of an exemplary (R)AN node 5 (base station) shown in FIG. 7. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N2/N3). A controller 57 controls the operation of the (R)AN node 5 in accordance with software stored in a memory 59. The software may be pre-installed in the memory 59 and/or may be downloaded via the telecommunication network 1 or from a removable data storage device (RMD), for example. The software includes, among other things, an operating system 61 and a communications control module 63. The communications control module 63 is responsible for handling (generating/sending/receiving) signaling between the (R)AN node 5 and other nodes, such as the UE 3 and the core network nodes. Such signaling includes appropriately formatted requests and responses relating to monitoring, controlling, and enforcing the number of UEs per network slice.

Core Network Node

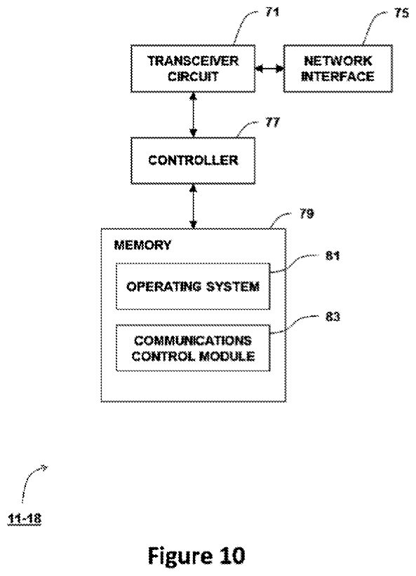

FIG. 10 is a block diagram illustrating the main components of a generic core network node (or function) shown in FIG. 7, for example, the AUSF 11, the AMF 12, the NSQ 13/NSSF 14, the UDM 15, the PCF 16, and the AAA-S 17/AAA-P 18. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, (R)AN node 5, and other core network nodes. Such signaling includes appropriately formatted requests and responses relating to monitoring, controlling, and enforcing the number of UEs per network slice.

Modifications and Alternatives

Detailed example aspects have been described above. As those skilled in the art will appreciate, a number of modifications and alternatives can be made to the above example aspects whilst still benefiting from the disclosure embodied therein. By way of illustration only a number of these alternatives and modifications will now be described.

In the above description, the UE, the (R)AN node, and the core network node are described for ease of understanding as having a number of discrete modules (such as the communication control modules). Whilst these modules may be provided in this way for certain applications, for example where an existing system has been modified to implement the above example aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example aspects, a number of software modules were described. As those skilled in the art will appreciate, the software modules may be provided in compiled or un-compiled form and may be supplied to the UE, the (R)AN node, and the core network node as a signal over a computer network, or on a recording medium. Further, the functionality performed by part or all of this software may be performed using one or more dedicated hardware circuits. However, the use of software modules is preferred as it facilitates the updating of the UE, the (R)AN node, and the core network node in order to update their functionalities.

The above example aspects are also applicable to ‘non-mobile’ or generally stationary user equipment.

Various other modifications will be apparent to those skilled in the art and will not be described in further detail here.

### LIST OF REFERENCES STATED IN THE PRESENT SPECIFICATION

[1] 3GPP TR 21.905: “Vocabulary for 3GPP Specifications”. V15.0.0 (2018-03)-
[2] 3GPP TS 23.501: “System Architecture for the 5G System; Stage 2”. V16.1.0 (2019-06)—http://www.3gpp.org/ftp/Specs/archive/23_series/23.501/23501-g20.zip
[3] 3GPP TS 23.502: “Procedures for the 5G System; Stage 2” V16.140 (2019-06)—http://www.3gpp.org/ftp/Specs/archive/23_series/23.502/23502-g20.zip
[4] Generic Network Slice Template https://www.gsma.com/newsroom/wp-content/uploads/NG.116-v1.0.pdf
[5] SA2 SID on Enhancement of Network Slicing Phase 2 agreed in SA2#134 24-28 June 2019, Sapporo, Japan
http://www.3gpp.org/ftp/Specs/archive/23_series/23.700-40/23700-40-020.zip

This application is based upon and claims the benefit of priority from European Patent Application No. 19218972.8, filed on Dec. 20, 2019, the disclosure of which are incorporated herein in their entirety by reference.

### REFERENCE SIGN LIST

1 MOBILE (CELLULAR OR WIRELESS) TELECOMMUNICATION SYSTEM

3 MOBILE DEVICE (UE)

5 BASE STATION

7 CORE NETWORK

11 AUTHENTICATION SERVER FUNCTION (AUSF)

12 ACCESS AND MOBILITY MANAGEMENT FUNCTION (AMF)

13 NETWORK SLICE QUOTA (NSQ)

14 NETWORK SLICE SELECTION FUNCTION (NSSF)

15 UNIFIED DATA MANAGEMENT (UDM) FUNCTION

16 POLICY CONTROL FUNCTION (PCF)

17 AUTHENTICATION, AUTHORISATION AND ACCOUNTING SERVER (AAA-S)

18 AUTHENTICATION, AUTHORISATION AND ACCOUNTING PROXY (AAA-P)

20 external IP network

31 TRANSCEIVER CIRCUIT

33 ANTENNA

35 USER INTERFACE

37 CONTROLLER

39 MEMORY

41 OPERATING SYSTEM

43 COMMUNICATIONS CONTROL MODULE

51 TRANSCEIVER CIRCUIT

53 ANTENNA

55 NETWORK INTERFACE

57 CONTROLLER

59 MEMORY

61 OPERATING SYSTEM

63 COMMUNICATIONS CONTROL MODULE

71 TRANSCEIVER CIRCUIT

75 NETWORK INTERFACE

77 CONTROLLER

79 MEMORY

81 OPERATING SYSTEM

83 COMMUNICATIONS CONTROL MODULE

What is claimed is:

1. A Network Function node for network slice quota, comprising:
a memory storing instructions; and
one or more processors configured to execute the instructions to:
receive a first request, from a core network node for mobility management, for service operation about quota of a network slice, including information indicating the network slice; and
send, to the core network node for mobility management, a first response to the first request, indicating a result of the service operation about the quota of the network slice.

2. The Network Function node for network slice quota according to claim 1, wherein
the result of the service operation about the quota of the network slice includes availability of the network slice.

3. The Network Function node for network slice quota according to claim 2, wherein
the first request is sent during Network Slice Specific Authentication and Authorization, NSSAA, procedure for the network slice, and
in a case where the availability of the network slice indicates that the network slice is unavailable, the result of the service operation about the quota of the network slice causes the core network node for mobility management to send a UE Configuration Update message to user equipment, UE, to change status of the information indicating the network slice from “pending” to “rejected”.

4. The Network Function node for network slice quota according to claim 2, wherein
the first request is sent during Network Slice Specific Authentication and Authorization, NSSAA, procedure for the network slice,
the one or more processors are further configured to:
receive a second request, from the core network node for mobility management, for updating the quota of the network slice, including information indicating the network slice, in a case where the availability of the network slice indicates that the network slice is available;
update the quota of the network slice, based on the second request; and
send, to the core network node for mobility management, a second response to the second request, including a result of the updating, and
the second response causes the core network node for mobility management to send a UE Configuration Update message to user equipment, UE, to change status of the information indicating the network slice from “pending” to “allowed”.

5. The Network Function node for network slice quota according to claim 1, wherein
the first request is sent due to revocation of Network Slice Specific Authentication and Authorization, NSSAA, procedure for the network slice,
the first request includes a request for incrementing the quota of the network slice,
the one or more processors are further configured to:
update the quota of the network slice by incrementing the quota of the network slice based on the request for incrementing the quota of the network slice, and wherein
the result of the service operation about the quota of the network slice causes the core network node for mobility management to send a UE Configuration Update message to user equipment, UE, to update of an allowed list of network slices by removing the network slice indicated by the first request, from the list.

6. The Network Function node for network slice quota according to claim 1, wherein
the first request is sent due to change of an allowed list or rejected list of network slices for user equipment, UE,
the first request includes a request for incrementing or decrementing the quota of the network slice,
the one or more processors are further configured to:
update the quota of the network slice by incrementing or decrementing the quota of the network slice based on the request for incrementing or decrementing the quota of the network slice.

7. The Network Function node for network slice quota according to claim 1, wherein
the quota of the network slice includes quota on at least one of a number of user equipment, UE, for the network slice and a number of Protocol Data Unit, PDU session for the network slice, and
the first request includes information indicating the at least one of the number of UE for the network slice and the number of PDU session for the network slice.

8. A core network node for mobility management, comprising:
a memory storing instructions; and
one or more processors configured to execute the instructions to:
send a first request, to a Network Function node for network slice quota, for service operation about quota of a network slice, including information indicating the network slice; and
receive from the Network Function node for network slice quota, a first response to the first request, indicating a result of the service operation about the quota of the network slice.

9. The core network node for mobility management according to claim 8, wherein
the result of the service operation about quota of the network slice includes availability of the network slice.

10. The core network node for mobility management according to claim 9, wherein
the one or more processors are configured to send the first request during Network Slice Specific Authentication and Authorization, NSSAA, procedure for the network slice, and
the one or more processors are further configured to:
send a UE Configuration Update message to user equipment to change status of the information indicating the network slice from “pending” to “rejected”, in a case where the availability of the network slice indicates that the network slice is unavailable.

11. The core network node for mobility management according to claim 9, wherein
the one or more processors are configured to send the first request during Network Slice Specific Authentication and Authorization, NSSAA, procedure for the network slice, and
the one or more processors are further configured to:
send a second request, to the Network Function node for network slice quota, for updating the quota of the network slice, including information indicating the network slice, in a case where the availability of the network slice indicates that the network slice is available;
receive from the Network Function node for network slice quota, a second response to the second request, including a result of the updating; and
send a UE Configuration Update message to user equipment, UE, to change status of the information indicating the network slice from “pending” to “allowed”, in response to the result of the updating.

12. The core network node for mobility management according to claim 8, wherein
the one or more processors are configured to send the first request due to revocation of Network Slice Specific Authentication and Authorization, NSSAA, procedure for the network slice,
the first request includes a request for incrementing the quota of the network slice,
the first request causes the Network Function node for network slice quota to update the quota of the network slice by incrementing the quota of the network slice,
the one or more processors are further configured to:
send a UE Configuration Update message to user equipment, UE, to update of an allowed list of network slices by removing the network slice indicated by the first request, from the list, in response to the first response.

13. The core network node for mobility management according to claim 8, wherein
the one or more processors are configured to send the first request due to change of an allowed list or rejected list of network slices for user equipment, UE,
the first request includes a request for incrementing or decrementing the quota of the network slice, and
the first request causes the Network Function node for network slice quota to update the quota of the network slice by incrementing or decrementing the quota of the network slice.

14. The core network node for mobility management according to claim 8, wherein
the quota of the network slice includes quota on at least one of a number of user equipment, UE, for the network slice and a number of Protocol Data Unit, PDU session for the network slice, and
the first request includes information indicating the at least one of the number of UE for the network slice and the number of PDU session for the network slice.

15. A controlling method for a Network Function node for network slice quota, the controlling method comprising:
receiving a first request, from a core network node for mobility management, for service operation about quota of a network slice, including information indicating the network slice; and
sending, to the core network node for mobility management, a first response to the first request, indicating a result of the service operation about the quota of the network slice.

16. The controlling method according to claim 15, wherein
the result of the service operation about the quota of the network slice includes availability of the network slice.

17. The controlling method according to claim 16, wherein
the first request is sent during Network Slice Specific Authentication and Authorization, NSSAA, procedure for the network slice, and
in a case where the availability of the network slice indicates that the network slice is unavailable, the result of the service operation about the quota of the network slice causes the core network node for mobility management to send a UE Configuration Update message to user equipment, UE, to change status of the information indicating the network slice from “pending” to “rejected”.

18. The controlling method according to claim 16, wherein
the first request is sent during Network Slice Specific Authentication and Authorization, NSSAA, procedure for the network slice,
the controlling method further comprises:
receiving a second request, from the core network node for mobility management, for updating the quota of the network slice, including information indicating the network slice, in a case where the availability of the network slice indicates that the network slice is available;
updating the quota of the network slice, based on the second request; and
sending, to the core network node for mobility management, a second response to the second request, including a result of the updating, and
the second response causes the core network node for mobility management to send a UE Configuration Update message to user equipment, UE, to change status of the information indicating the network slice from “pending” to “allowed”.

19. The controlling method according to claim 15, wherein
the first request is sent due to revocation of Network Slice Specific Authentication and Authorization, NSSAA, procedure for the network slice,
the first request includes a request for incrementing the quota of the network slice,
the controlling method further comprises:
updating the quota of the network slice by incrementing the quota of the network slice based on the request for incrementing the quota of the network slice, and wherein
the result of the service operation about the quota of the network slice causes the core network node for mobility management to send a UE Configuration Update message to user equipment, UE, to update of an allowed list of network slices by removing the network slice indicated by the first request, from the list.

20. The controlling method according to claim 15, wherein
the first request is sent due to change of an allowed list or rejected list of network slices for user equipment, UE,
the first request includes a request for incrementing or decrementing the quota of the network slice,
the controlling method further comprises:
updating the quota of the network slice by incrementing or decrementing the quota of the network slice based on the request for incrementing or decrementing the quota of the network slice.

21. The controlling method according to claim 15, wherein
the quota of the network slice includes quota on at least one of a number of user equipment, UE, for the network slice and a number of Protocol Data Unit, PDU session for the network slice, and
the first request includes information indicating the at least one of the number of UE for the network slice and the number of PDU session for the network slice.

22. A controlling method for a core network node for mobility management, the controlling method comprising:
sending a first request, to a Network Function node for network slice quota, for service operation about quota of a network slice, including information indicating the network slice; and
receiving, from the Network Function node for network slice quota, a first response to the first request, indicating a result of the service operation about the quota of the network slice.

23. The controlling method according to claim 22, wherein
the result of the service operation about quota of the network slice includes availability of the network slice.

24. The controlling method according to claim 23, wherein
the sending includes sending the first request during Network Slice Specific Authentication and Authorization, NSSAA, procedure for the network slice, and
the controlling method further comprises:
sending a UE Configuration Update message to user equipment to change status of the information indicating the network slice from “pending” to “rejected”, in a case where the availability of the network slice indicates that the network slice is unavailable.

25. The controlling method according to claim 23, wherein
the sending includes sending the first request during Network Slice Specific Authentication and Authorization, NSSAA, procedure for the network slice, and
the controlling method further comprises:
sending a second request, to the Network Function node for network slice quota, for updating the quota of the network slice, including information indicating the network slice, in a case where the availability of the network slice indicates that the network slice is available;
receiving, from the Network Function node for network slice quota, a second response to the second request, including a result of the updating; and
sending a UE Configuration Update message to user equipment, UE, to change status of the information indicating the network slice from “pending” to “allowed”, in response to the result of the updating.

26. The controlling method according to claim 22, wherein
the sending includes sending the first request due to revocation of Network Slice Specific Authentication and Authorization, NSSAA, procedure for the network slice,
the first request includes a request for incrementing the quota of the network slice,
the first request causes the Network Function node for network slice quota to update the quota of the network slice by incrementing the quota of the network slice,
the controlling method further comprises:
sending a UE Configuration Update message to user equipment, UE, to update of an allowed list of network slices by removing the network slice indicated by the first request, from the list, in response to the first response.

27. The controlling method according to claim 22, wherein
the sending includes sending the first request due to change of an allowed list or rejected list of network slices for user equipment, UE,
the first request includes a request for incrementing or decrementing the quota of the network slice, and
the first request causes the Network Function node for network slice quota to update the quota of the network slice by incrementing or decrementing the quota of the network slice.

28. The controlling method according to claim 22, wherein
the quota of the network slice includes quota on at least one of a number of user equipment, UE, for the network slice and a number of Protocol Data Unit, PDU session for the network slice, and
the first request includes information indicating the at least one of the number of UE for the network slice and the number of PDU session for the network slice.
